(19) United States
(12) Patent Application Publication
(10) Pub. No.: US 2006/0231012 A1
(43) Pub. Date: Oct. 19, 2006

(54) Portable emergency reflective signal balloon with reflective streamers

(76) Inventors: Andrew Wamester, Middletown, CT (US); Jeffrey Scalia, Berlin, CT (US)

Correspondence Address: ANDREW WAMESTER, 25 BUTTERNUT STREET, MIDDLETOWN, CT, 06457, US

(21) Appl. No.: 11/108,851

(22) Filed: Apr. 19, 2005

(51) Int. Cl. B64B 1/40

(52) U.S. Cl. 116/210

(57) ABSTRACT

Portable Emergency Reflective Signal Balloon with Streamers embodies a highly reflective mirror finish, MYLAR™, balloon with streamers attached to a monofilament tether, packaged in a pouch with a cannister of gas, which is lighter than air, such as helium, which can be deployed as needed as an emergency signaling device.

### BACKGROUND OF INVENTION

1. Field of Invention

This invention relates in general to balloons and in particular to use as a portable emergency signaling device.

2. Description of Prior Art

In the past if a person(s) were stranded outdoors (stranded divers, lost/injured hikers, powerless water craft) signal mirrors, flares, distress flags were used to signal for help. Flares & distress flags require that the stranded party be aware of the presence & location of assistance. Flags on small water craft are usually located to close to the water line to be seen at any great distance. U.S. Pat. No. 4,696,252 is similar to our idea, but contains a battery & electronics section, and is radar reflective in design. Our idea, Andrew Wamester & Jeff Scalia, comprises of a highly reflective inflatable balloon, made of material such as MYLAR™ that has attached reflective strips made of the same material, that is attached with a tether to a wristband that the person(s) wears. The uninflated, folded balloon, tether, and a small canister of helium would be packaged in a small waterproof pouch that could easily be carried on the person(s), in a backpack, with diving gear, or in a water craft safety kit.

When assistance is needed the balloon would be inflated with the Helium from the cannister. With the tether attached to the wristband or a suitable fixed object, the balloon & streamers would rise above the person(s) position as to be seen above the curvature of the earth, so as not to be lost over the horizon. The highly reflective surface of the balloon & it's streamers, would reflect the sun's rays, light from a search party, or one's own search light, in a random pattern due to the streamers reflection & movement in a breeze. If a person(s) were to become incapacitated the device would remain aloft, allowing a continued chance of rescue. Unlike mirrors or flares the device will stay aloft for days being visible to potential rescuers. Unlike U.S. Pat. No. 4,696,252, our idea is a visual rescue device, not a radar device.

### SUMMARY OF THE INVENTION

The principal objective of this invention is to provide a cost friendly device which can be carried on one's person, when engaging in outdoor activities, such as boating, diving, hiking, climbing, etc that can be used to signal rescuers to a person(s) location when in distress.

It's also an objective of this invention to provide such a device that is both lightweight and of simple inexpensive construction, that is easily & reliably implemented by it's user.

The foregoing objectives can be accomplished by providing a small packet which can be easily affixed to a person, or object. The packet would contain monofilament tether which would be affixed to the packet and to an uninflated, folded MYLAR™ balloon. The packet would also contain a small canister of Helium, similar to a portable CO2 cannister. When needed the balloon with streamers could be inflated with the cannister of Helium causing it to rise from its pouch to the end of the tether & remain aloft. The sun's rays, light from a search party, or one's own search light would reflect of the surface of the balloon & the random waving motion of the streamers. This reflective action could alert potential rescuers from all directions that are allowed. The height of the device can be controlled as required by the user. A 75′ length of monofilament would be used & usually be sufficient enough to be seen unobstructed.

### BRIEF DESCRIPTION OF THE DRAWINGS

FIG. 1: Perspective View of All Elements

FIG. 2: Perspective View of Device in Use at Sea

FIG. 3: Perspective View of Device in Use While Climbing/Hiking

FIG. 4 Perspective View of Device in Use While Snowbound

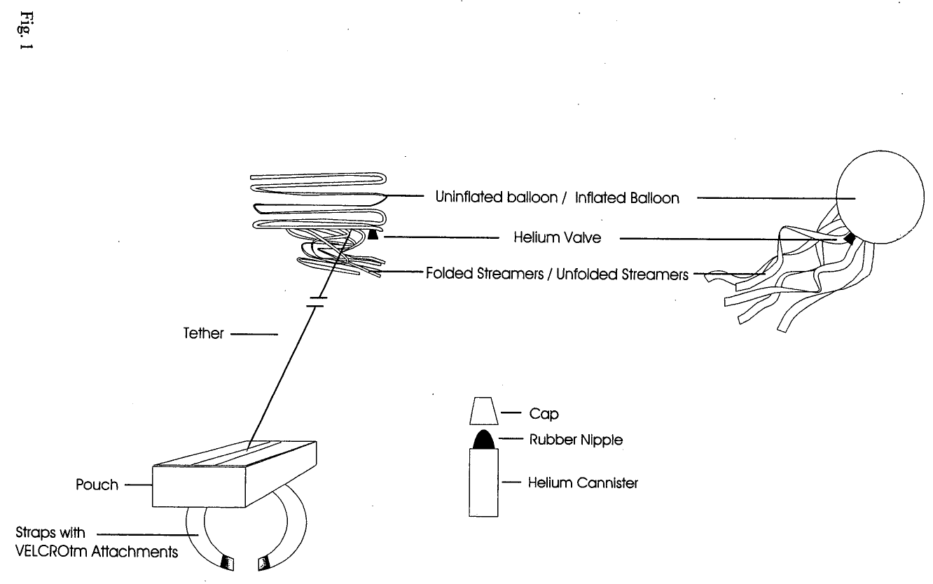

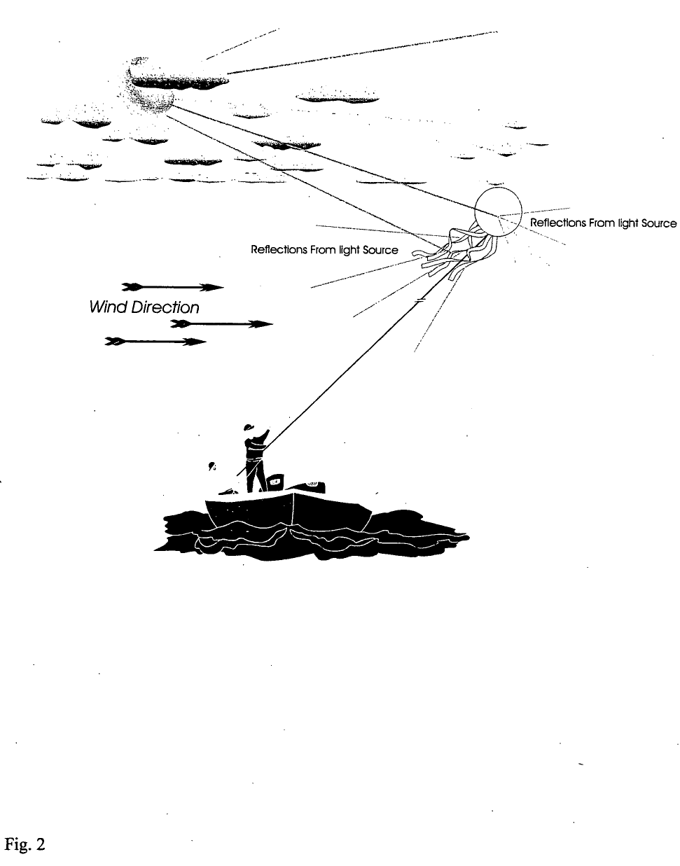

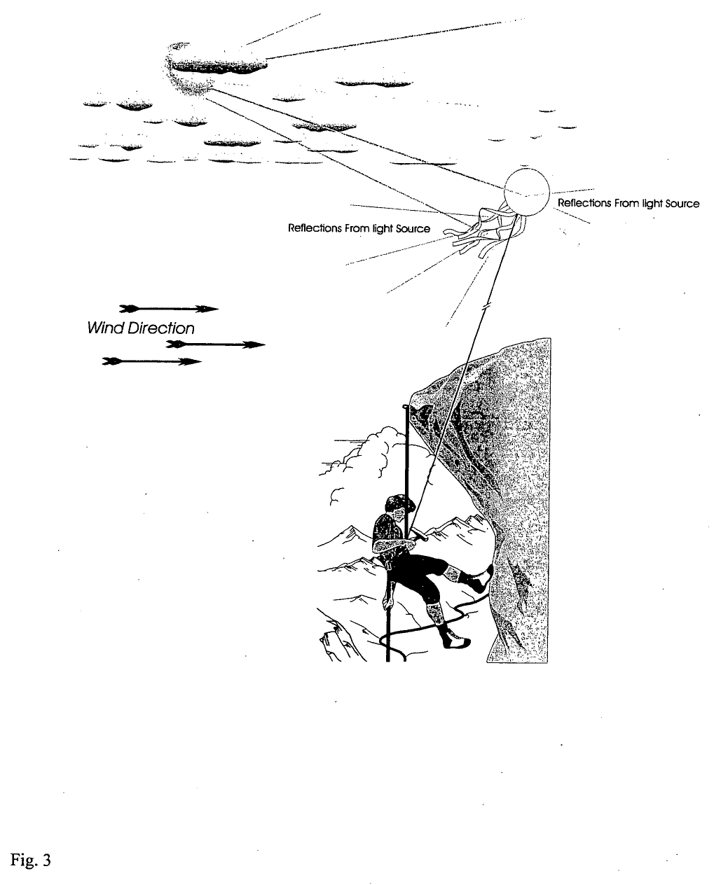

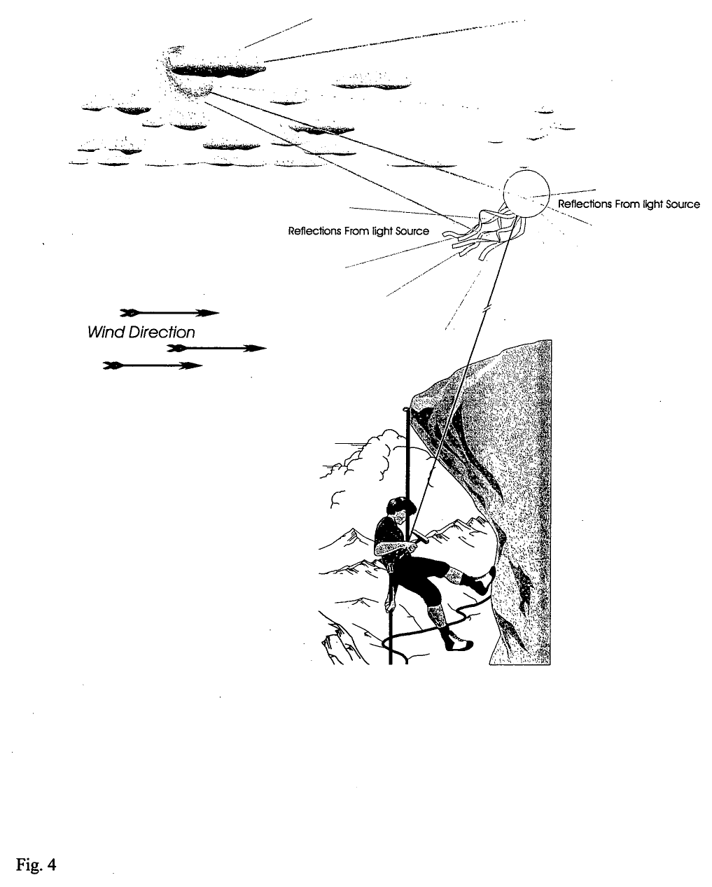

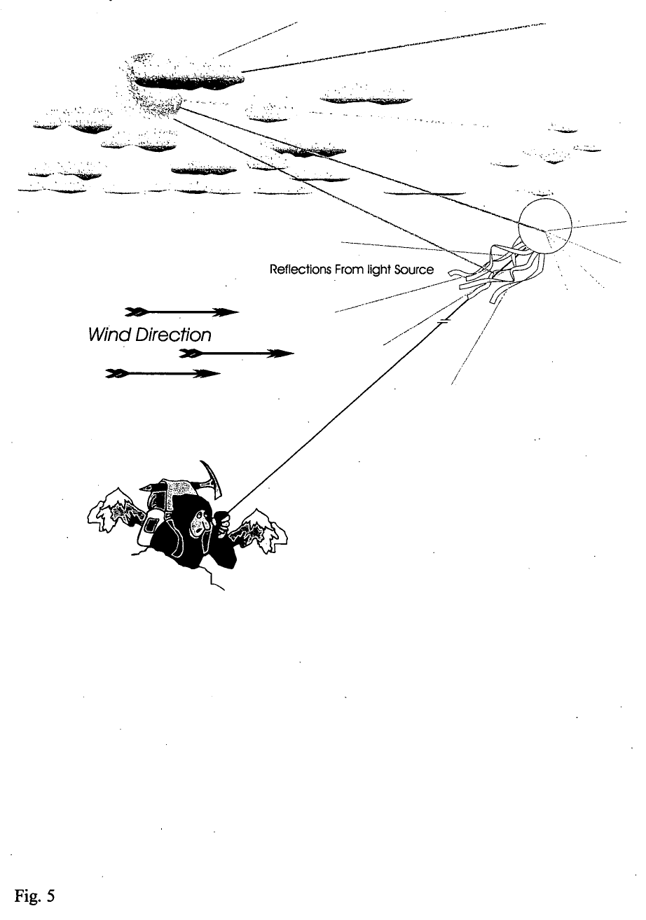

### DESCRIPTION OF THE PREFERRED EMBODIMENTS

The preferred embodiment of the invention as shown in the drawings, includes a zippered pouch made of a nylon material which is 3″×3″×6″ in dimension, with (2) 6″ long straps made of a nylon material with a VELCRO™ means of attaching to one's body or a fixed object, by wrapping one strap around the said object joining with the VELCRO™ on the second strap.

Included in the pouch would be a 2″ diameter×5″ long cannister of a pressurized gas which is lighter than air, such as helium, which has a means of inflating a MYLAR™ balloon which has dimensions of 24″ diameter.

The uninflated MYLAR™ balloon contained in the pouch would contain (2) round 24″ diameter halves. One half which contains (5) 48″ long×3″ wide MYLAR™ streamers, radiating out from one edge. The streamers are end to end on the 3″ edge using up 15″ of the diameter edge. The (2) halves of the balloon would be attached at it's outside edges creating an airtight seal. A valve is attached to the completed edge which allows the gas from the cannister to inflate the balloon. All material used in the construction of the balloon and it's streamers will be comprised of a material which has a highly reflective mirror finish that is also lightweight, such as MYLAR™.

The balloon would be connected to the pouch with a 75′ length of a monofilament tether

The foregoing description of the preferred embodiment of the invention has been presented for the purpose of illustration ans description. It is not intended to be exhaustive or to limit the invention to the precise form disclosed. Many modifications & variations are possible in light of the above teaching. It is intended that the scope of the invention be limited not by this detailed description but rather by the claims appended here to.

As a reward for our contribution we claim the rights to the following invention. The emergency signal balloon with attached reflective streamers.

1) A device comprising of:
a) Cannister of a gas, which is lighter than air, such as helium.
b) Highly reflective balloon with streamers.
c) Pouch to contain all elements with VELCRO™ straps for attachment to a fixed object.
d) Tether of monofilament line connecting the pouch to the balloon with streamers.

2) Uninflated, folded balloon with streamers, coiled tether, cannister of gas which is lighter than air, such as helium, to be contained within the pouch when not in use.

3) When needed the balloon would be inflated with gas from cannister allowing it to rise aloft while attached a fixed object via the enclosed tether.
